(19) United States
(12) Patent Application Publication
(10) Pub. No.: US 2008/0147330 A1
(43) Pub. Date: Jun. 19, 2008

(54) METHOD AND APPARATUS FOR COMBINING SUB-THERAPEUTIC DOSAGES

(76) Inventor: W. Matthew Warnock, Sandy, UT (US)

Correspondence Address: Kunzler & McKenzie, 8 EAST BROADWAY, SUITE 600, SALT LAKE CITY, UT, 84111, US

(21) Appl. No.: 11/952,866

(22) Filed: Dec. 7, 2007

Related U.S. Application Data
(60) Provisional application No. 60/874,739, filed on Dec. 14, 2006.

(51) Int. Cl. G06F 19/00

(52) U.S. Cl. 702/19

(57) ABSTRACT

A method and apparatus are disclosed for combining sub-therapeutic dosages. A practitioner and/or computer program product selects at least one primary effect and selects a plurality of ingredients that have the at least one primary effect. In addition, the practitioner and/or computer program product scores a strength of the at least one primary effect and each secondary effect for each ingredient. The practitioner and/or computer program product selects a subset of the plurality of ingredients. An average of the primary effect strengths of the selected ingredients exceeds a specified primary effect threshold. In addition, an average of the secondary effect strengths of the selected ingredients is less than a specified secondary effect threshold. The practitioner and/or computer program product combines a sub-therapeutic dosage of each ingredient of the subset as a combined therapeutic dosage.

### CROSS-REFERENCES TO RELATED APPLICATIONS

This application claims priority to U.S. Provisional Patent Application No. 60/874,739 entitled “PORTFOLIO METHOD FOR FORMULATING NEW MEDICINES BY COMBINING SUB-THERAPEUTIC DOSES OF KNOWN MEDICINES” and filed on Dec. 14, 2006 for W. Matthew Warnock, which is incorporated herein by reference.

### BACKGROUND OF THE INVENTION

1. Field of the Invention

This invention relates to sub-therapeutic dosages and more particularly relates to combining sub-therapeutic dosages to provide a therapeutic effect.

2. Description of the Related Art

Medicines are generally dosage-dependent. The effect of a medicine is typically a function of the dosage administered. A higher dosage produces a greater response than a lower dosage. Often a significant dosage is required before any response is observed. A lesser dosage may elicit no measurable response. The dosage required in order to elicit a desired response is referred to herein as a therapeutic dosage.

A sub-therapeutic dosage is a dosage that is not expected to elicit a measurable response. For example, if the therapeutic dosage of a medicine is two milligrams per kilogram (2 mg/kg) of body weight, a sub-therapeutic dosage may be one milligram per kilogram (1 mg/kg) dosage.

Conventional therapeutic dosages are determined through statistical analysis of average dose-response curves. However, human bodies are unique, and respond differently to different medicines. Some people respond more or less strongly than the average, making the medicine more or less effective than normal. In addition, almost all medicines have multiple effects, including side effects and possible adverse reactions. These may be stronger in some individuals than in others, but are also often dose-dependent. Since “normal” doses are based on the mean response, there will always be extreme responses, both on the desired or primary effect, and on the undesired secondary or side effects, including allergic and other adverse reactions.

Because all of these adverse reactions are generally dose-dependent, one way to reduce the incidence and severity of these adverse reactions would be to reduce the normal dosage. However, this would also reduce the effectiveness of the medicine, which is also dose-dependent. A sub-therapeutic dose is unlikely to cause significant adverse effects, but is also usually an ineffective medicine.

Conventional western medicine generally prescribes a single compound for a given problem. Sub-therapeutic dosages of a medicine are infrequently administered because the sub-therapeutic dosage is considered ineffective at best (although sub-therapeutic dosages of multiple ingredients may be therapeutic, as will be shown below). At worst, it is thought that administering sub-therapeutic doses may postpone and/or interfere with proper treatment.

### SUMMARY OF THE INVENTION

From the foregoing discussion, there is a need for a method and apparatus for combining sub-therapeutic dosages into a therapeutic dosage. Beneficially, such a method and apparatus would provide improved efficacy and safety relative to a therapeutic dose of a single ingredient.

The present invention has been developed in response to the present state of the art, and in particular, in response to the problems and needs in the art that have not yet been fully solved by currently available sub-therapeutic dosage combination methods. Accordingly, the present invention has been developed to provide a method and apparatus for combining sub-therapeutic dosages that overcome many or all of the above-discussed shortcomings in the art.

By combining sub-therapeutic doses of multiple ingredients, the effects of the various ingredients can be accumulated to provide an effective therapeutic dosage, which provides advantages over a single-ingredient formulation. Although individuals will still vary in their response to each ingredient, one person is unlikely to have extreme responses to multiple ingredients at the same time. Individuals that don't respond normally to one ingredient are likely to respond more predictably to others. In this manner, the medicine is both more predictably effective across the broad range of individuals, and has fewer and smaller adverse reactions.

The present invention provides a method for combining sub-therapeutic doses in specific ways to provide a desired primary therapeutic effect, while actively minimizing undesired secondary effects. Means for evaluating and selecting the several ingredients is provided, together with means to calculate the dosage of each individual ingredient in the formula, and for the formula as a whole. Importantly, the present invention may be used with herbal medicines, nutraceuticals, conventional drugs, or other medicines.

A method of the present invention is presented for combining sub-therapeutic dosages. In one embodiment, the method includes selecting at least one primary effect, selecting a plurality of ingredients, scoring strengths, selecting a subset of ingredients, and combining sub-therapeutic dosages.

The method includes selecting at least one primary effect and selecting a plurality of ingredients that have the at least one primary effect. In addition, the method comprises scoring a strength of the at least one primary effect and each secondary effect for each ingredient. In addition, the method includes selecting a subset of the plurality of ingredients. An average of the primary effect strengths of the selected ingredients exceeds a specified primary effect threshold. In addition, an average of the secondary effect strengths of the selected ingredients is less than a specified secondary effect threshold. The method further comprises combining a sub-therapeutic dosage of each ingredient of the subset as a combined therapeutic dosage.

The apparatus for combining sub-therapeutic dosages is provided with a plurality of means configured to perform the steps of selecting at least one primary effect, selecting a plurality of ingredients, scoring a strength, selecting a subset of ingredients, and combining sub-therapeutic dosages.

The apparatus includes means for selecting at least one primary effect. The apparatus also includes means for selecting a plurality of ingredients that have the at least one primary effect. In addition, the apparatus includes means for scoring a strength of the at least one primary effect and each secondary effect for each ingredient. The apparatus further comprises means for ordering the ingredients based on the primary effect and means for identifying a subset of ingredients of the plurality of ingredients with a similar secondary effect. The method includes means for removing at least one ingredient of the subset of ingredients from the plurality of ingredients.

The apparatus further comprises means for selecting a subset of the plurality of ingredients. Each ingredient Aᵢ is selected from the plurality of ingredients Aᵢ for i=l to n using a formula: if

$$\frac{{\sum }_{i = 1}^{n} {e}_{i P}}{n} > {T}_{p}$$

for each primary effect and

$$\frac{{\sum }_{i = 1}^{n} {e}_{i S}}{n} > {T}_{s}$$

for each secondary effect, then dᵢ=d_{iT}=/n for each i and

$${d}_{0} = {\sum }_{i = 1}^{n} \frac{{d}_{i T}}{n} .$$

In the formula, n is a number of the plurality of ingredients, Aᵢ is an ith single ingredient, e_{iP} is a strength of the primary effect of ingredient Aᵢ, Tₚ is the specified primary effect threshold, eᵢₛ is a strength of a specified secondary effect of Aᵢ, Tₛ is the specified secondary effect threshold, dᵢ is the sub-therapeutic dosage of Aᵢ, d_{iT} is the therapeutic dosage of Aᵢ, and d₀ is the combined therapeutic dosage.

The apparatus includes means for calculating a sub-therapeutic dosage for each ingredient as a therapeutic dosage for the ingredient divided by a number of ingredients in the subset. In addition, the apparatus comprises means for combining the sub-therapeutic dosage of each ingredient of the subset as a combined therapeutic dosage.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention combines sub-therapeutic dosages of a plurality of ingredients into a therapeutic dosage. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a graph showing dosage/response points;

FIG. 2 is a graph showing a linear regression of dosage/response points;

FIG. 3 is a graph showing a sigmoid curve model of dosage/response points;

FIG. 4 is a graph showing a distribution of subject responses to a dosage;

FIG. 5 is a schematic flow chart diagram illustrating one embodiment of a sub-therapeutic dosage combining method of the present invention;

FIG. 6 is a schematic flow chart diagram illustrating one embodiment of a ingredient selection method of the present invention;

FIGS. 7A, 7B, and 7C are table diagrams illustrating a relationship of exemplary ingredients of the present invention;

FIG. 8 is a graph showing a combined effect of exemplary ingredients of the present invention;

FIG. 9 is a graph showing an averaged combined effect of exemplary ingredients of the present invention; and

FIG. 10 is a schematic block diagram illustrating one embodiment of a computer in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

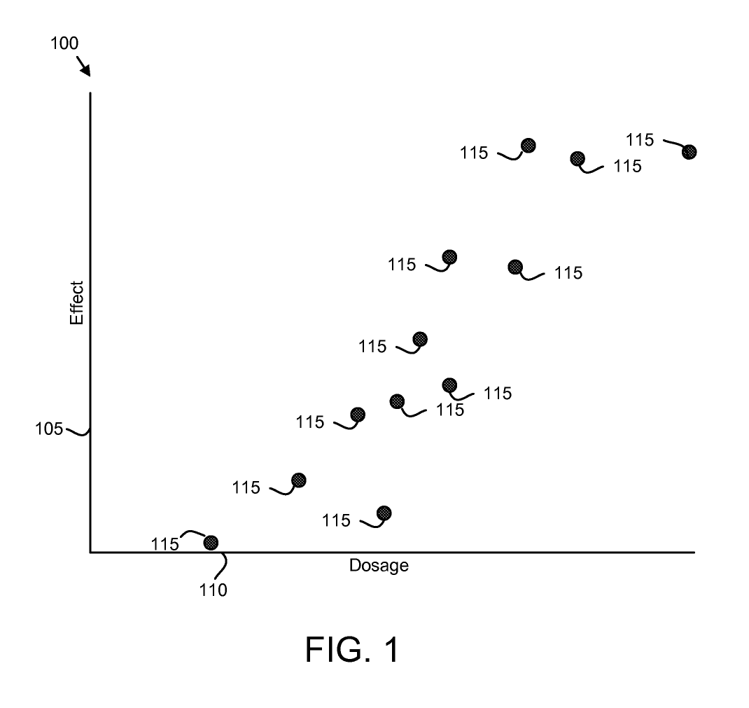

FIG. 1 is a graph 100 showing dosage/response points 115. The graph 100 is illustrative of determining a therapeutic dosage for specified ingredient. As depicted, the graph 100 plots the effect 105 of an ingredient administered to one or more subjects in a plurality of dosages 110 as dosage/response points 115.

The effect 105 may be measured as an absolute measure, as observed change, and/or as an effectiveness. For example, the effect 105 may be an absolute measure such as diastolic blood pressure in a subject. In an alternate example, the effect 105 may be observed change such as an observed reduction in pain in the subject. In another example, the effect 105 may be an effectiveness such as observed reduction in diastolic blood pressure as a percentage of the highest observed pressure of the subject.

The ingredient may be administered to a plurality of individuals with a plurality of dosages 110. In one embodiment, the ingredient is normalized to the body mass of the individual. For example, a specified dosage 110 may be normalized to three grams (3 g) for a man with a mass of seventy-five kilograms (75 kg) and four grams (4 g) for another man with a mass of one hundred kilograms (100 kg).

The graph 100 may be constructed from the results of a clinical trial that is conducted to determine a therapeutic dosage for the ingredient. Although for simplicity, a graph 100 is shown with eleven (11) dosage/response points 115, a clinical trial may generate any number of dosage/response points 115.

Even with the dosages 110 normalized to body mass, the reaction of each individual to a dosage 110 may vary significantly. Differences in the pharmacokinetics and the pharmacodynamics of an individual and an ingredient result in significant differences in effect.

As a result, the graph 100 is primarily useful in determining an average therapeutic dosage for the ingredient. Although for illustrative purposes the data is shown on the graph 100, the data may be used by a computer program product. The computer program product may include a tangible storage device such as a hard disk drive having a computer readable program. The computer readable program may be executed on a computer as is well known to those of skill in the art, causing the computer to process and manipulate the data. The data of the graph 100 may be used to determine a therapeutic dosage as will be described hereafter.

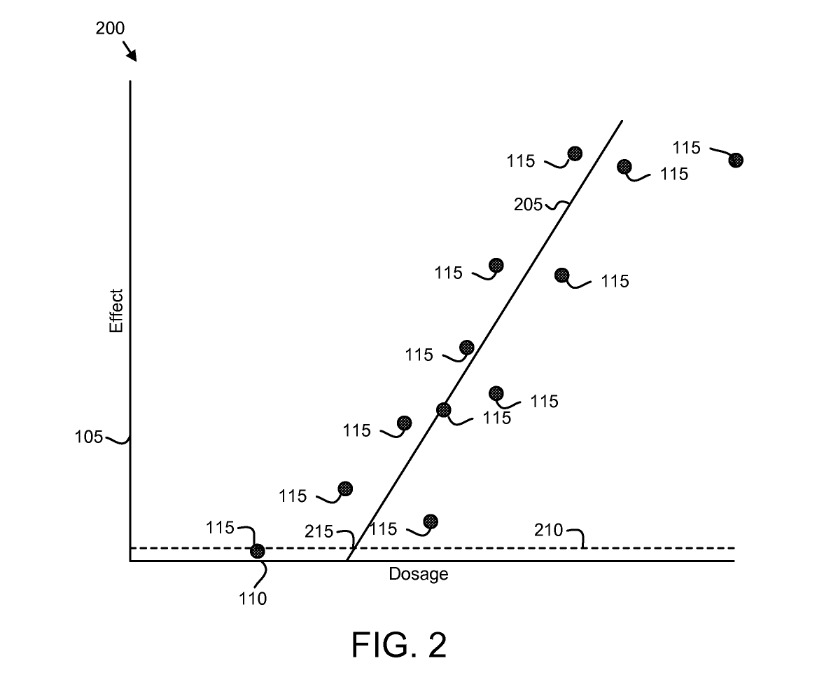

FIG. 2 is a graph 200 showing a linear regression 205 of the dosage/response points 115 of FIG. 1. The description of the graph 200 refers to elements of FIG. 1, like numbers referring to like elements. In one embodiment, the linear regression 205 is an expression of the equation y=bx+c where y is the effect 105, x is the dosage 110, and b and c are calculated constants. The linear regression 205 may be calculated using a least-squares analysis, polynomial fitting, and trend line regression as is well known to those of skill in the art.

In one embodiment, a minimum effect 210 is established. The minimum effect 210 may be a minimum desired effect. Alternatively, the minimum effect 210 may be an absence of a clinically observed effect 105. In a certain embodiment, the minimum effect 210 is established at a level where fifty percent (50%) of subjects have the desired minimum effect, a measure referred to hereinafter as EC50. Alternatively, the minimum effect 210 is established at a level where eighty percent (80%) of subjects have the desired minimum effect, a measure referred to hereinafter as EC80.

A therapeutic dosage 215 may be the dosage 110 of the ingredient that results in the minimum desired effect that satisfies EC50. The minimum desired effect may be referred to as effective, therapeutic, clinical, or the like. Alternatively, the therapeutic dosage 215 may be the dosage 110 of the ingredient that results in the minimum desired effect satisfying EC80.

The therapeutic dosage 215 may be calculated as the dosage 110 that yields the minimum effect 210 when applied to the linear regression equation. In one example, the linear regression equation is Equation 1, where x is measured in milligrams, and the minimum effect is a numerical value of seven point six (7.6), the therapeutic dosage 215 may be calculated as thirteen milligrams (13 mg).

y=0.2x+5 Equation 1

In one embodiment, a computer program product calculates the linear regression 205 of the dosage/response points 115. In addition, the computer program product may calculate the therapeutic dosage 215 from a specified minimum effect 210.

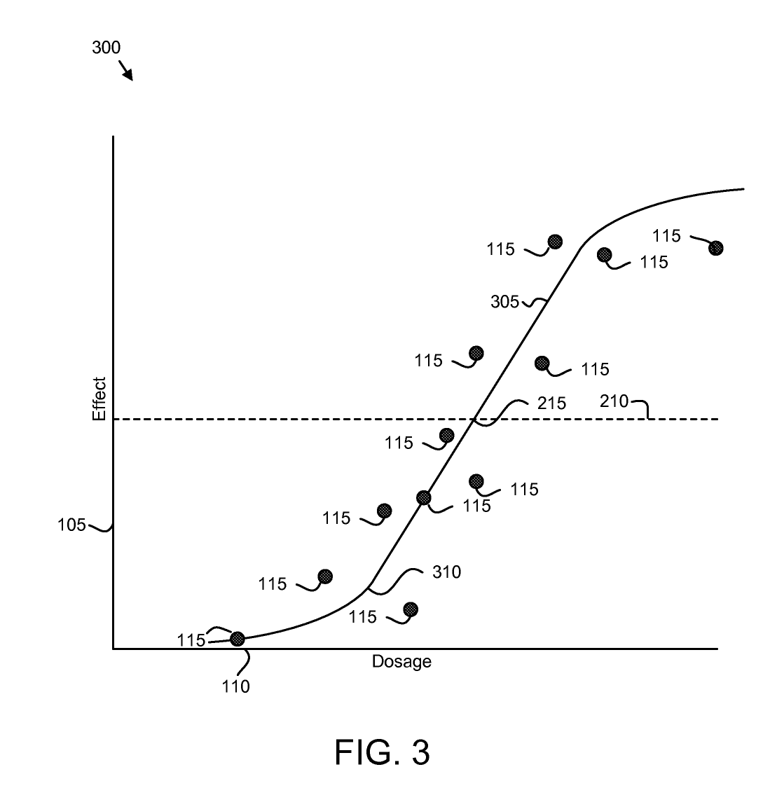

FIG. 3 is a graph 300 showing a sigmoid curve model 305 of the dosage/response points 115 of FIG. 1. The description of the graph 300 refers to elements of FIGS. 1-2, like numbers referring to like elements. In one embodiment, the sigmoid curve model 305 is an approximation of the dosage/response points 115 in the form of Equation 2 where y is the effect 105, x is the dosage 110, and b and c are calculated constants.

y=b(1/(1+e^{-x}))+c Equation 2

A computer program product or practitioner may derive a therapeutic dosage 215 from the sigmoid curve model 305. In one embodiment, the therapeutic dosage 215 is calculated as the dosage 110 that yields the minimum effect 210 when applied to the sigmoid curve model 305. In an alternate embodiment, the therapeutic dosage 215 may be selected at the dosage 110 at a sigmoid curve model inflexion point 310.

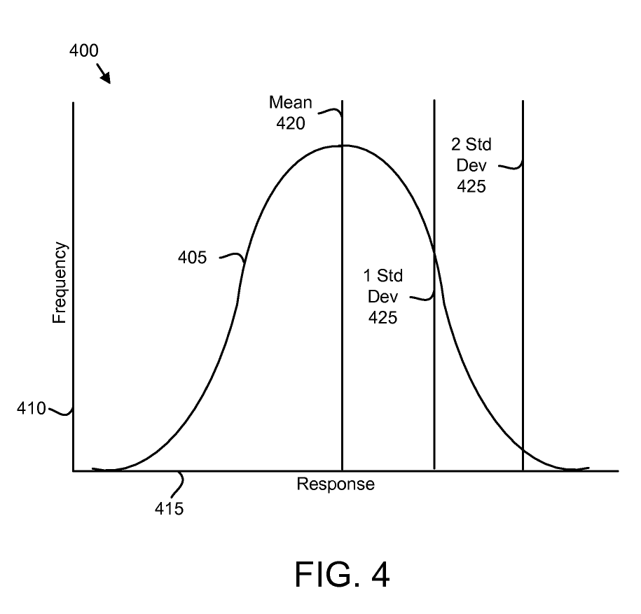

FIG. 4 is a graph 400 showing a distribution of subject responses to a dosage of an ingredient. The description of the graph 300 refers to elements of FIGS. 1-3, like numbers referring to like elements. In one embodiment, the graph 400 illustrates a response 415 to a specified dosage of the ingredient by a plurality of subjects. The specified dosage may be normalized to the body mass of each subject.

The response 415 may be analogous to the effect 105 of FIGS. 1-3. The graph 400 shows a frequency 410 indicative of a number of subjects that have a specified response 415. A bell curve 405 is fitted to the clinical data such as the dosage/response points 115 of FIG. 1 as is well known to those of skill in the art. The bell curve 405 yields a mean 420 and first and second standard deviations 425a, 425b for the subject population.

In one embodiment, a computer program product calculates the bell curve 405 from the clinical data. Alternatively, a practitioner may manually calculate the bell curve 405. The therapeutic dosage 215 for the ingredient may be selected for a specified response 415. For example, the therapeutic dosage 215 may be selected at the mean response 420, satisfying the EC50 criteria. Alternatively, the therapeutic dosage 215 may be selected for a one standard deviation response 425. In one embodiment, the therapeutic dosage 215 is selected where eighty percent (80%) of the subjects have the desired response, satisfying EC80.

The present invention employs calculations of therapeutic dosages for multiple ingredients to combine sub-therapeutic dosages of the ingredients as will be described hereafter. One of skill in the art will recognize that the present invention may use therapeutic dosages calculated with other methods.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

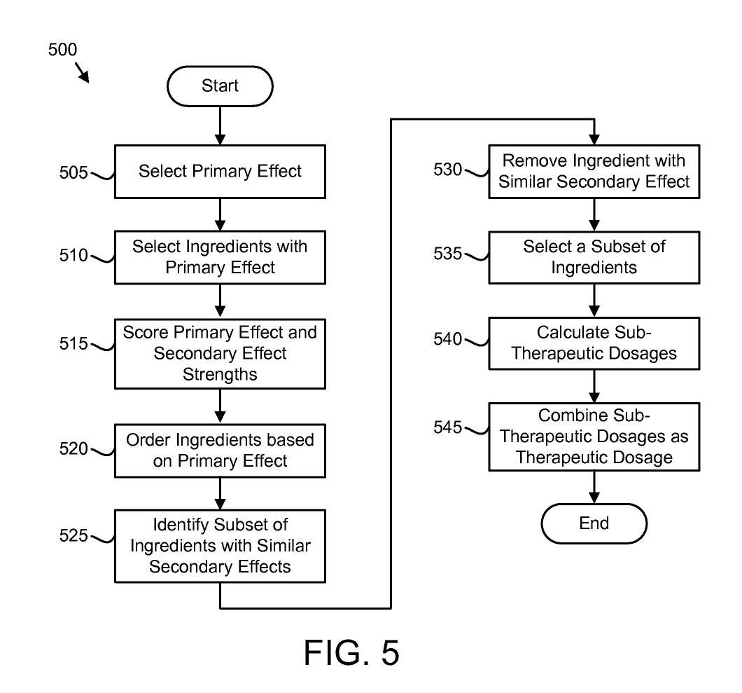

FIG. 5 is a schematic flow chart diagram illustrating one embodiment of a sub-therapeutic dosage combining method 500 of the present invention. The method 500 may be practiced by a practitioner, by a computer program product, and/or by a practitioner employing the computer program product. The description of the method 500 refers to elements of FIGS. 1-4, like numbers referring to like elements.

The method 500 begins and the practitioner selects 505 a primary effect. The primary effect may be a desired subject response. In one embodiment, the primary effect is symptomatic, wherein the symptoms alleviated. For example, the primary effect may be a reduction in blood pressure. Alternatively, the primary effect may be tonic. A tonic effect strengthens the body of the subject. The practitioner may select 505 a plurality of primary effects. For example, the practitioner may select 505 one or more symptomatic effects and one or more tonic effects.

The practitioner may select 505 the primary effect in response to need, such as a need to reduce blood pressure. In an alternate embodiment, the practitioner selects 505 the primary effect of a target ingredient, such an ingredient that is being prepared as commercial product. For example, the practitioner may select 505 a sedative primary effect when devising a formulation for a product comprising chamomile. Although for simplicity, the method 500 will be described for a single primary effect, one of skill in the art will recognize that the invention may be practiced with a selection of any number of primary effects.

The practitioner and/or computer program product selects 510 a plurality of ingredients that have primary effect. In one embodiment, the computer program product consults a database of ingredients and selects each ingredient that has the primary effect. In addition, the practitioner may add ingredients to and/or remove ingredients from the plurality of ingredients. Alternatively, the practitioner may select each ingredient of the plurality of ingredients.

The practitioner and/or computer program product may score 515 a strength of the primary effect and each secondary effect for each ingredient. The computer program product may consult the database of ingredients and retrieve the strength of the primary effect and the strength of each secondary effect for each ingredient. Alternatively, the practitioner may retrieve the strength of the primary effect and the strength of each secondary effect for each ingredient from a reference work. If an ingredient does not have a specified secondary effect, the strength of the secondary effect may be zero (0).

A secondary effect may be an undesirable effect, such as a risk of organ damage. However, secondary effects may also be positive though not necessarily sought by the practitioner. Ingredients often have secondary effects. The present invention mitigates the strength of unwanted secondary effects as will be discussed hereafter.

In one embodiment, the primary and secondary effect strengths are scored using a rate of effect. The rate of effect may be a time interval required for a therapeutic dosage 215 of the ingredient to have a desired effect. Alternatively, the primary and secondary effect strengths are scored using a potency. In one embodiment, the potency is a measure of magnitude of the effect.

In a certain embodiment, the primary and secondary effect strengths are scored using a combination of rate of effect and potency. The strength may be calculated using equation 3, where e is the strength, r is the rate of effect, p is the potency, a is a rate scaling factor and b is a potency scaling factor.

e=ar+bp Equation 3

In one embodiment, the practitioner and/or computer program product orders 520 ingredients based on the primary effect. For example, the computer program product may order 520 ingredients in descending order from the ingredient with the strongest primary effect. Similarly, the practitioner and/or computer program product may order ingredients with equivalent primary effects in descending order from the ingredient with the weakest secondary effect.

In one embodiment, the practitioner and/or computer program product identifies 525 a secondary effect subset of ingredients with a similar secondary effect. For example, if a first and second ingredient shares a first secondary effect, but computer program product may identify 525 a secondary effect subset comprising the first and second ingredient.

The practitioner and/or computer program product may remove 530 at least one ingredient of the secondary effect subset from the plurality of ingredients. Continuing the example above, the computer program product may remove 530 the first ingredient from the plurality of ingredients.

The practitioner and/or computer program product selects 535 a subset of the plurality of ingredients. An average of the primary effect strengths of the selected ingredients exceeds a specified primary effect threshold. The primary effect threshold may be a specified rate of effect. Alternatively, the primary effect threshold may be a specified potency. In addition, an average of the secondary effect strengths of the selected ingredients is less than a specified secondary effect threshold. The secondary effect threshold may also be a specified rate of effect for a specified potency.

In one embodiment, the practitioner and/or computer program product selects 535 at least one ingredient that mutually potentiates another ingredient. For example, a first ingredient may be selected 535 for increasing the primary effect strength of a second ingredient.

In one embodiment, the practitioner and/or computer program product may remove ingredients from the plurality of ingredients beginning with the ingredient with the lowest primary effect. The practitioner and/or computer program product may continue to remove ingredients until the average of the primary strengths of the ingredients exceeds the specified primary effect threshold.

In one embodiment, the practitioner and/or computer program product calculates 540 a sub-therapeutic dosage of each selected ingredient. The sub-therapeutic dosage may be calculated using Equation 4 where dᵢ is the sub-therapeutic dosage of the ingredient, d_{iT} is the therapeutic dosage, and n is the sub-therapeutic divisor. In one embodiment, the sub-therapeutic divisor is a number of the selected ingredients.

dᵢ=d_{iT}/n Equation 4

The practitioner and/or computer program product may further combine 545 the sub-therapeutic dosage of each ingredient of the subset as a combined therapeutic dosage and the method 500 ends. By combining sub-therapeutic dosages of the selected ingredients, the resulting combination has a therapeutic dosage for the primary effect while the secondary effects of each of the selected ingredients are mitigated. For example, an individual is less likely to have an allergic reaction to the combined ingredients than to a therapeutic dosage of any one of the ingredients. In addition, because different individuals react differently to various ingredients, the combined ingredients are typically effective across a broader range of individuals than each component ingredient.

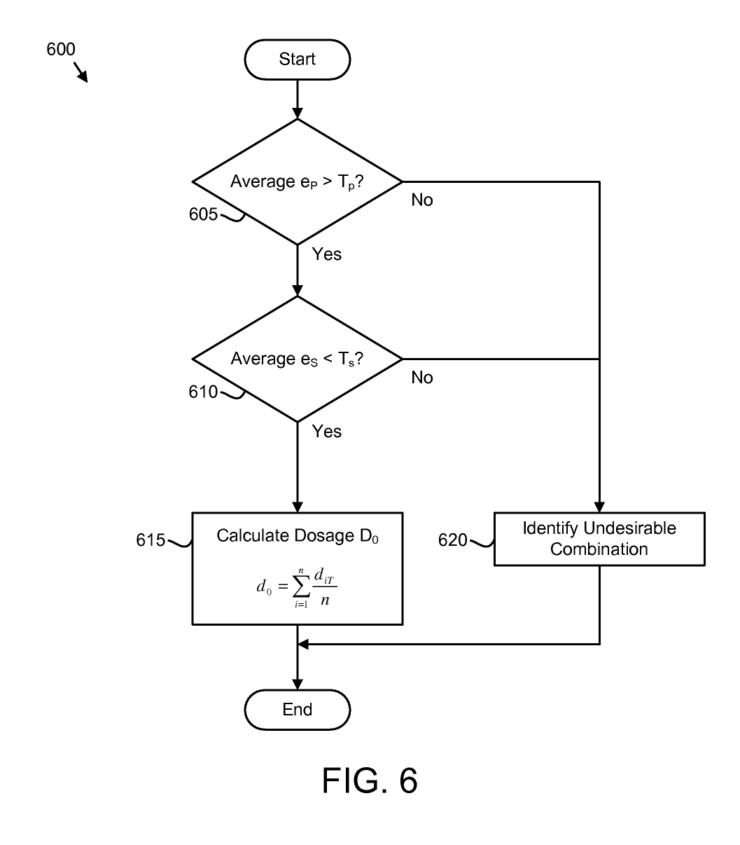

FIG. 6 is a schematic flow chart diagram illustrating one embodiment of an ingredient selection method 600 of the present invention. The method 600 may be practiced by a practitioner, by a computer program product, and/or by a practitioner employing the computer program product. The description of the method 600 refers to elements of FIGS. 1-5, like numbers referring to like elements.

The method 600 may be applied to a combination of ingredients. Step 535 of FIG. 5 may use the method 600 to select a subset of ingredients. The method 600 may be used to test one or more combinations of ingredients to determine a desirable combination.

For example, method 600 may be iteratively applied to multiple combinations of the ingredients. Step 535 may select the combination with a highest average primary effect strength, a lowest average secondary effect strength, or a combination of high average primary effect strength and low average secondary effect strength.

In one embodiment, the computer program product constructs a multidimensional matrix for each possible combination of ingredients. The computer program product may further evaluate whether each combination using the method 600. WHAT?

Alternatively, the computer program product may construct the multidimensional matrix and select two possible combinations of ingredients from the matrix. The computer program product may then evaluate each combination using the method 600 and calculate an improvement vector. The improvement vector may indicate changes to the combinations of ingredients that are likely to result in a more favorable combination of ingredients. The computer program product may use the improvement vector to select a third combination of ingredients that satisfies the improvement vector. The computer program product may use the third combination of ingredients to calculate another improvement vector and combination of ingredients, repeating the process until an optimum combination of ingredients is found.

The practitioner and/or computer program product determines 605 if the combination of ingredients satisfies Equation 5, where n is a number of the plurality of ingredients, Aᵢ is an ith single ingredient, e_{iP} is a strength of the primary effect of ingredient Aᵢ, Tₚ is the specified primary effect threshold.

$$\frac{{\sum }_{i = 1}^{n} {e}_{i P}}{n} > {T}_{p} \qquad Equation 5$$

If the combination of ingredients does not satisfy Equation 5, the practitioner and/or computer program product may identify 620 the combination as undesirable. In one embodiment, the identified combination is no longer considered.

If the combination of ingredients satisfies Equation 5, the practitioner and/or computer program product further determines 610 if the combination of ingredients satisfies Equation 6, where eᵢₛ is a strength of a specified secondary effect of Aᵢ, and Tₛ is the specified secondary effect threshold

$$\frac{{\sum }_{i = 1}^{n} {e}_{i S}}{n} < {T}_{s} \qquad Equation 6$$

If the combination of ingredients does not satisfy Equation 6, the practitioner and/or computer program product may identify 620 the combination as undesirable and the method 600 ends. If the combination of ingredients satisfies Equation 6, the practitioner and/or computer program product calculates 615 a therapeutic dosage of the combination of ingredients and the method 600 ends. In one embodiment, the dosage is calculated using Equation 7.

$${d}_{0} = {\sum }_{i = 1}^{n} \frac{{d}_{i T}}{n} \qquad Equation 7$$

The method 600 allows the practitioner and/or computer program product to screen a significant number of ingredient combinations. Thus the practitioner may rapidly identifying promising combinations of ingredients.

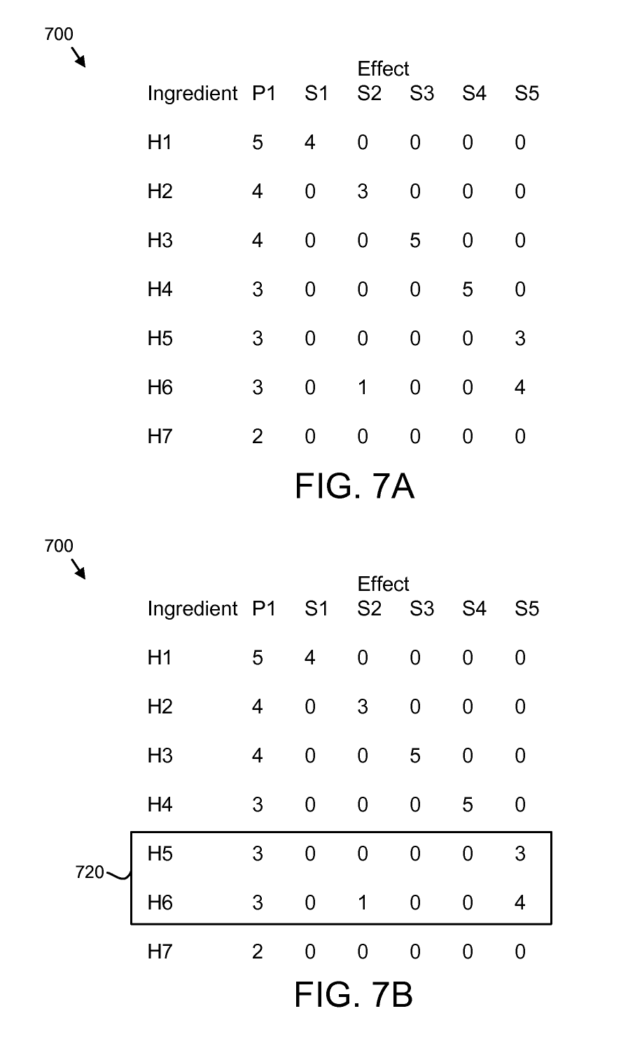

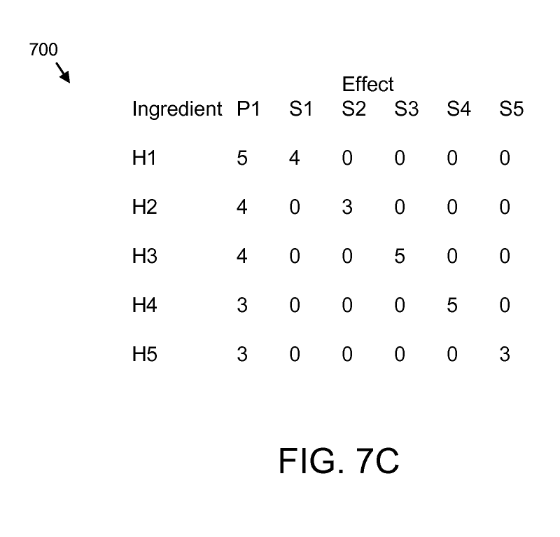

FIGS. 7A, 7B, and 7C are table diagrams 700 illustrating a relationship of exemplary ingredients of the present invention. The description of the diagrams 700 refers to elements of FIGS. 1-6, like numbers referring to like elements, is illustrative of the methods 500, 600 of FIGS. 5 and 6.

In FIG. 7A, a plurality of exemplary ingredients H1-7 are listed. The practitioner and/or computer program product may select 510 the ingredients H1-7 because of a primary effect. In the diagrams 700, each of the ingredients H1-7 has the primary effect P1.

The ingredients H1-7 also have a plurality of secondary effects S1-5. Each of the secondary effects S1-5 of the ingredients H1-7 is listed in the diagram 700. The practitioner and/or computer program product may score 515 the strength of the primary effect P1 and each secondary effect S1-5 for each ingredient H1-7. In addition, the practitioner and/or computer program product may order 520 the ingredients H1-7 based on the primary effect P1. The ingredients H1-7 are shown ordered from greatest primary effect to least primary effect.

In FIG. 7B, the practitioner and/or computer program product identifies 525 a secondary effect subset 720 of ingredients in the diagram 700 with a similar secondary effect S5. As shown, ingredients H5 and H6 are identified 525 as belonging to the secondary effect subset 720.

The practitioner and/or computer program product may remove 530 at least one ingredient of the subset of ingredients from the diagram. For example, the computer program product may remove 530 ingredient H6 as shown in FIG. 7C.

The practitioner and/or computer program product selects 535 a subset of the plurality of ingredients where the average of the primary effect strengths of the selected ingredients exceeds the specified primary effect threshold. For example, if the primary effect threshold is three point six (3.6), the combination of ingredients H1, H2, H3, H4, H5, and H7 has an average primary effect of three point five (3.5) and does not exceed the primary threshold. However, the combination of ingredients H1, H2, H3, H4, and H5 has an average primary effect of three point eight (3.8) and does exceed the primary threshold. Therefore FIG. 7C is shown with selected subset of ingredients H1, H2, H3, H4, and H5.

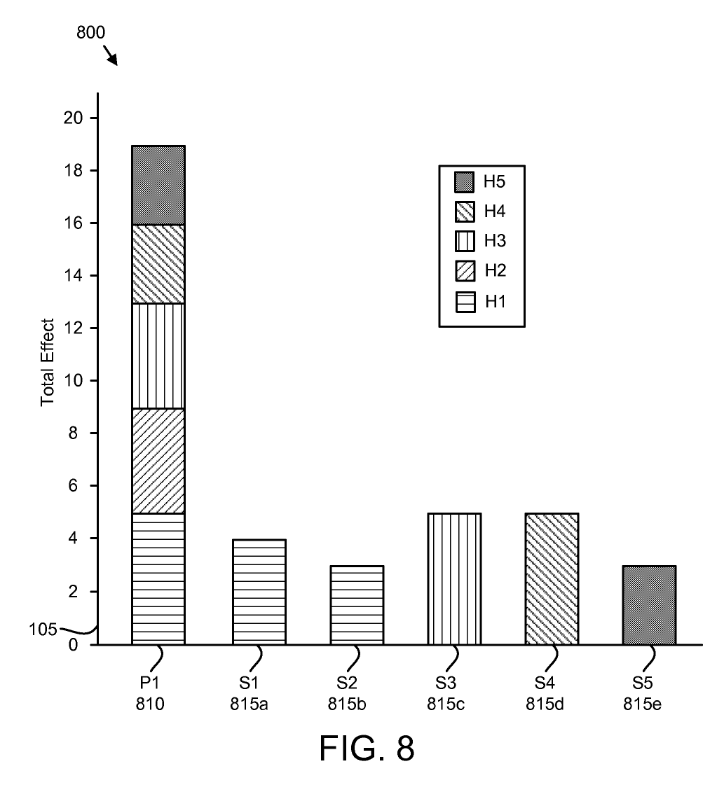

FIG. 8 is a graph 800 showing a combined effect of exemplary selected ingredients H1-5 of FIG. 7C. The effects 105 of the primary effect 810 and the secondary effects 815 for the selected ingredients H1-5 are shown along a vertical axis.

Because the primary effect 810 of the selected ingredients H1-5 is additive, the primary effect 810 of the combine selected ingredients H1-5 is significantly greater than any of the secondary effects 815. Thus the combination of the selected ingredients H1-5 provides the primary effect 810 while mitigating the secondary effects 815.

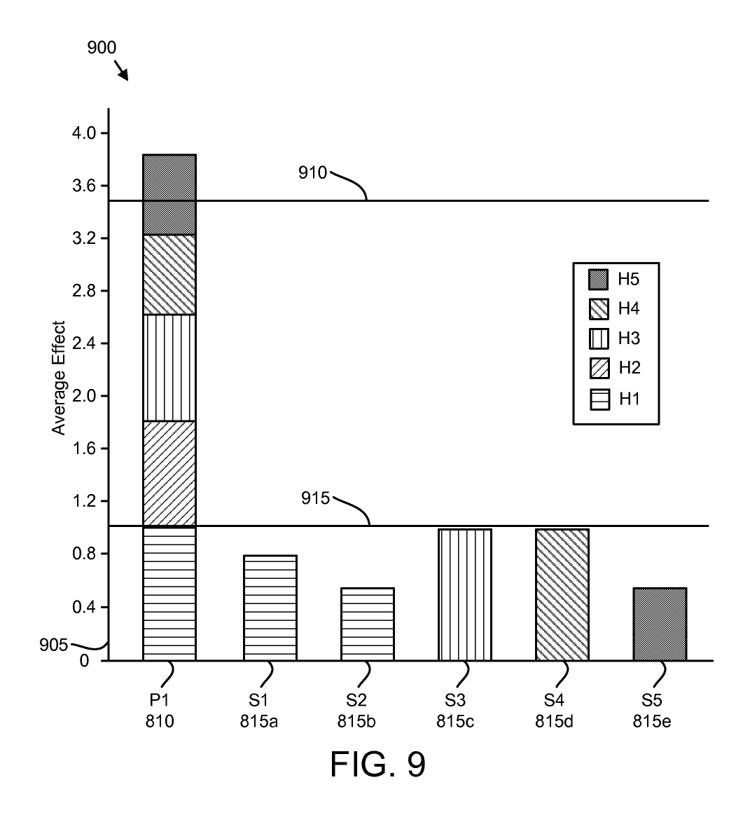

FIG. 9 is a graph showing an averaged combined effect of exemplary selected ingredients H1-5 of FIG. 8. The average effects 905 of the primary effect 810 and the secondary effects 815 for the selected ingredients H1-5 are shown along a vertical axis. A primary effect threshold 910 and a secondary effect threshold 915 are also shown.

The selected ingredients H1-5 satisfies the selection criteria of the method 600 of FIG. 6 as the average of the primary effects 810 exceeds the primary effect threshold 910 and as none of the averages of the secondary effects 815 exceed the secondary effect threshold 915.

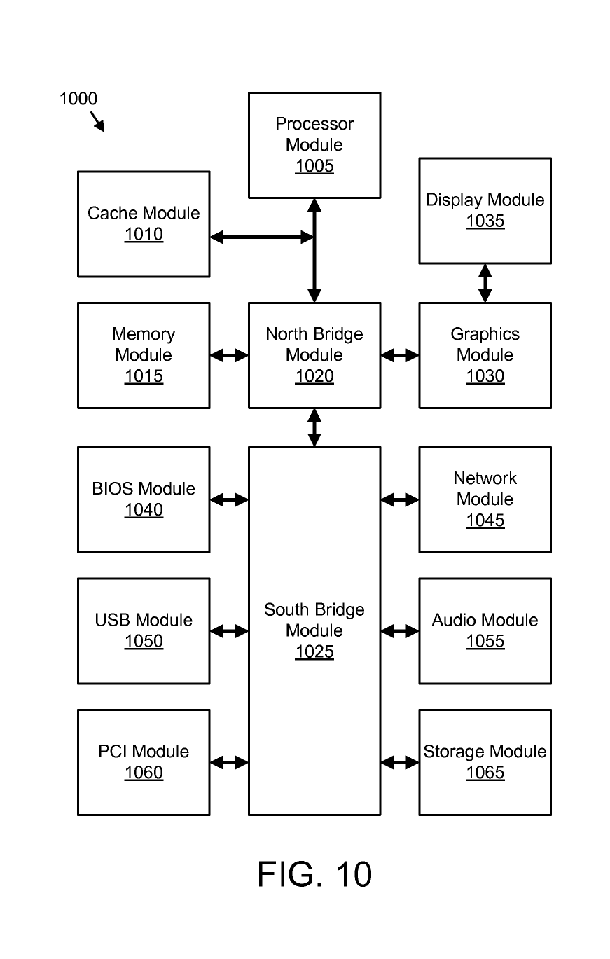

FIG. 10 is a schematic block diagram illustrating one embodiment of a computer 1000 in accordance with the present invention. The computer 1000 includes a processor module 1005, a cache module 1010, a memory module 1015, a north bridge module 1020, a south bridge module 1025, a graphics module 1030, a display module 1035, a basic input/output system (“BIOS”) module 1040, a network module 1045, a Universal Serial Bus (USB) module 1050, an audio module 1055, a peripheral component interconnect (“PCI”) module 1060, and a storage device 1065.

The processor module 1005, cache module 1010, memory module 1015, north bridge module 1020, south bridge module 1025, graphics module 1030, display module 1035, BIOS module 1040, network module 1045, USB module 1050, audio module 1055, PCI module 1060, and storage device 1065, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory module 1015 stores software instructions and data. The processor module 1005 executes the software instructions and manipulates the data as is well known to those skilled in the art. The software instructions and data may be configured as one or more computer readable programs. The computer readable programs may comprise a computer program product and be tangibly stored in the storage device 1065. The storage device 1065 may be a hard disk drive, an optical storage device, a holographic storage device, a micromechanical storage device, a semiconductor storage device, or the like. In one embodiment, the computer 1000 executes one or more computer program products that carry out the methods 500, 600 of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for combining sub-therapeutic dosages, the method comprising:
selecting at least one primary effect;
selecting a plurality of ingredients that have the at least one primary effect;
scoring a strength of the at least one primary effect and each secondary effect for each ingredient;
selecting a subset of the plurality of ingredients wherein an average of the primary effect strengths of the selected ingredients exceeds a specified primary effect threshold and an average of the secondary effect strengths of the selected ingredients is less than a specified secondary effect threshold; and
combining a sub-therapeutic dosage of each ingredient of the subset as a combined therapeutic dosage.

2. The method of claim 1, the method further comprising calculating the sub-therapeutic dosage for each ingredient, wherein the sub-therapeutic dosage is calculated as a therapeutic dosage for the ingredient divided by a specified sub-therapeutic divisor.

3. The method of claim 2, wherein the sub-therapeutic divisor is a number of ingredients in the subset.

4. The method of claim 3, wherein each ingredient Aᵢ is selected from the plurality of ingredients Aᵢ for i=l to n using a formula: if
$$\frac{{\sum }_{i = 1}^{n} {e}_{i P}}{n} > {T}_{p}$$
for each primary effect and
$$\frac{{\sum }_{i = 1}^{n} {e}_{i S}}{n} < {T}_{s}$$
for each secondary effect, then dᵢ=d_{iT}/n for each i and
$${d}_{0} = {\sum }_{i = 1}^{n} \frac{{d}_{i T}}{n} ,$$
where n is a number of selected of ingredients, Aᵢ is an ith single ingredient, e_{iP} is a strength of the primary effect of ingredient Aᵢ, Tₚ is the specified primary effect threshold, eᵢₛ is a strength of a specified secondary effect of Aᵢ, Tₛ is the specified secondary effect threshold, dᵢ is the sub-therapeutic dosage of Aᵢ, d_{iT} is the therapeutic dosage of Aᵢ, and d₀ is the combined therapeutic dosage.

5. The method of claim 1, the method further comprising ordering the ingredients based on the primary effect.

6. The method of claim 5, the method further comprising ordering the plurality of ingredients from greatest primary effect to least primary effect.

7. The method of claim 1, the method further comprising:
identifying a secondary effect subset of ingredients of the plurality of ingredients with a similar secondary effect; and
removing at least one ingredient of the secondary effect subset of ingredients from the plurality of ingredients.

8. The method of claim 1, wherein primary and secondary effect strengths are scored using a rate of effect.

9. The method of claim 1, wherein primary and secondary effect strengths are scored using a potency.

10. The method of claim 1, wherein primary and secondary effect strengths are scored using a sum of a potency multiplied by a potency scaling factor and a rate of effect multiplied by a rate scaling factor.

11. The method of claim 1, wherein the at least one primary effect is symptomatic.

12. The method of claim 1, wherein the at least one primary effect is tonic.

13. The method of claim 1, wherein a plurality of the primary effects comprise at least one symptomatic effect and at least one tonic effect.

14. The method of claim 1, wherein at least one ingredient mutually potentiates at least one other ingredient.

15. The method of claim 1, wherein the ingredients comprise herbs.

16. A computer program product comprising a tangible storage device having a computer readable program, wherein the computer readable program when executed on a computer causes the computer to:
select at least one primary effect;
select a plurality of ingredients that have the at least one primary effect;
score a strength of the at least one primary effect and each secondary effect for each ingredient;
select a subset of the plurality of ingredients wherein an average of the primary effect strengths of the selected ingredients exceeds a specified primary effect threshold and an average of the secondary effect strengths of the selected ingredients is less than a specified secondary effect threshold; and
combine a sub-therapeutic dosage of each ingredient of the subset as a combined therapeutic dosage.

17. The computer program product of claim 16, wherein the computer readable program further causes the computer to calculate the sub-therapeutic dosage for each ingredient as a therapeutic dosage for the ingredient divided by a number of ingredients in the subset.

18. The computer program product of claim 17, wherein each ingredient Aᵢ is selected from the plurality of ingredients Aᵢ for i=l to n using a formula: if
$$\frac{{\sum }_{i = 1}^{n} {e}_{i P}}{n} > {T}_{p}$$
for each primary effect and
$$\frac{{\sum }_{i = 1}^{n} {e}_{i S}}{n} < {T}_{s}$$
for each secondary effect, then dᵢ=d_{iT}/n for each i and
$${d}_{0} = {\sum }_{i = 1}^{n} \frac{{d}_{i T}}{n} ,$$
where n is a number of selected ingredients, Aᵢ is an ith single ingredient, e_{iP} is a strength of the primary effect of ingredient Aᵢ, Tₚ is the specified primary effect threshold, eᵢₛ is a strength of a specified secondary effect of Aᵢ, Tₛ is the specified secondary effect threshold, dᵢ is the sub-therapeutic dosage of Aᵢ, d_{iT} is the therapeutic dosage of Aᵢ, and d₀ is the combined therapeutic dosage.

19. The computer program product of claim 18, wherein the computer readable program further causes the computer to:
order the ingredients based on the primary effect;
identify a secondary effect subset of ingredients of the plurality of ingredients with a similar secondary effect; and
remove at least one ingredient of the secondary effect subset of ingredients from the plurality of ingredients.

20. An apparatus for combining sub-therapeutic dosages, the apparatus comprising:
means for selecting at least one primary effect;
means for selecting a plurality of ingredients that have the at least one primary effect;
means for scoring a strength of the at least one primary effect and each secondary effect for each ingredient;
means for ordering the ingredients based on the primary effect;
means for identifying a secondary effect subset of ingredients of the plurality of ingredients with a similar secondary effect;
means for removing at least one ingredient of the secondary effect subset of ingredients from the plurality of ingredients;
means for selecting a subset of the plurality of ingredients wherein each ingredient Aᵢ is selected from the plurality of ingredients Aᵢ for i=1 to n using a formula: if
$$\frac{{\sum }_{i = 1}^{n} {e}_{i P}}{n} > {T}_{p}$$
for each primary effect and
$$\frac{{\sum }_{i = 1}^{n} {e}_{i S}}{n} < {T}_{s}$$
for each secondary effect, Aᵢ is an ith single ingredient, e_{iP} is a strength of the primary effect of ingredient Aᵢ, Tₚ is the specified primary effect threshold, eᵢₛ is a strength of a specified secondary effect of Aᵢ, Tₛ is the specified secondary effect threshold, dᵢ is the sub-therapeutic dosage of Aᵢ, d_{iT} is the therapeutic dosage of Aᵢ, and d₀ is the combined therapeutic dosage;
means for calculating a sub-therapeutic dosage for each ingredient as a therapeutic dosage for the ingredient divided by a number of ingredients in the subset; and
means for combining the sub-therapeutic dosage of each ingredient of the subset as a combined therapeutic dosage.
